(19) United States
(12) Patent Application Publication
(10) Pub. No.: US 2021/0372474 A1
(43) Pub. Date: Dec. 2, 2021

(54) BEARING ASSEMBLIES, ROLLER BEARING UNITS, RACES, METHODS OF MAKING SAME, AND APPARATUS COMPRISING SAME

(71) Applicant: Element Six (UK) Limited, Oxfordshire (GB)

(72) Inventors: Neil Edward Seth CHARMAN, Oxfordshire (GB); Mehmet Serdar OZBAYRAKTAR, Oxfordshire (GB); Mark Gregory MUNDAY, Oxfordshire (GB); Christopher John Howard WORT, Oxfordshire (GB); Lifen DENG, Oxfordshire (GB)

(21) Appl. No.: 16/763,831

(22) PCT Filed: Nov. 14, 2018
(86) PCT No.: PCT/EP2018/081242

§ 371 Date: May 13, 2020

(30) Foreign Application Priority Data
Nov. 14, 2017 (GB) 1718797.2

(51) Int. Cl. F16C 33/36; F16C 33/62; F16C 33/64

(52) U.S. Cl. CPC F16C 33/36; F16C 33/62; F16C 2206/58; F16C 2206/04; F16C 2206/56; F16C 33/64

(57) ABSTRACT

A bearing assembly includes a roller bearing unit, an inner race and an outer race. The roller bearing unit is formed of polycrystalline super-hard material having a mean mass density of at most 4.5 g/cm³ and a volume-weighted arithmetic mean thermal conductivity of at least 100 W/m·K.

This disclosure relates generally to roller bearing assemblies, roller bearing units comprising polycrystalline super-hard material, races for bearing assemblies, methods for making roller bearing units, and apparatus comprising roller bearing assemblies, particularly but not exclusively gas turbines.

WO 2004/019830 discloses a spinal implant including diamond on a load bearing surface. The implant comprise free-standing sintered polycrystalline diamond (PCD), formed without a substrate. Sintered PCD is noted as being suitable for load-bearing and articulation surfaces without a lubricant.

WO 2012/050674 discloses diamond-enhanced thrust-bearing assemblies that include two pairs of bearing rings, each of which comprises silicon-bonded diamond material. The silicon-bonded diamond material may be formed on a cemented carbide support element, or the bearing rings may be formed entirely of the silicon-bonded diamond material.

WO 2014/139941 discloses a roller-bearing assembly comprising a roller element and a race element. The roller element comprises a roller bearing surface defined by a super-hard structure, and the race element comprises a race bearing surface, which may also be defined by a super-hard structure. A super-hard structure may comprise polycrystalline diamond (PCD) material, polycrystalline cubic boron nitride (PCBN) material, silicon carbide-bonded diamond (SCD) material, or a diamond film. The super-hard structure may comprise a super-hard layer joined to a super-hard substrate. The roller element may comprise PCD material structure attached to a cobalt-cemented tungsten carbide substrate.

WO 2014/189763 discloses a thrust bearing assembly comprising a plurality of bearing units, each of which comprises polycrystalline diamond (PCD) and a cobalt-cemented tungsten carbide substrate, or substrate-less free-standing PCD bearing units.

WO 2016/089680 discloses bearing assemblies for use in pumps, turbines, compressors, turbo expanders, or other mechanical systems, comprising a super-hard bearing surface. A continuous super-hard bearing unit may include a polycrystalline diamond (PCD) table bonded to a cobalt-cemented tungsten carbide substrate. Alternatively, the substrate may be omitted and the continuous super-hard bearing unit may be a super-hard material.

There is a need for bearing assemblies having reduced wear rate and reduced mass, and/or improved thermal behaviour, particularly but not exclusively for gas turbines such as may be used in aeronautical propulsion systems.

Viewed from a first aspect, there is provided a bearing assembly comprising a roller bearing unit, an inner race and an outer race, the roller bearing unit is formed of polycrystalline super-hard material having a mean mass density of at most 4.5 g/cm³ and a volume-weighted arithmetic mean thermal conductivity of at least 100 W/m·K.

Viewed from a second aspect, there is provided an apparatus comprising an example bearing assembly.

Viewed from a third aspect, there is provided an aircraft propulsion system comprising an example bearing assembly.

Viewed from a fourth aspect, there is provided a method of making a roller bearing unit for an example bearing assembly, the method including providing a precursor body including a precursor volume of polycrystalline super-hard material, and having a mean mass density of at most 4.5 g/cm³, and a volume-weighted arithmetic mean thermal conductivity of at least 100 W/m·K; processing the precursor body to remove material such that the precursor volume is bounded by a surface defining dimensions within 10% of the corresponding dimensions of the roller bearing unit; and processing the precursor volume to provide the roller bearing unit.

Various roller bearing units, races and assemblies, and apparatus comprising same are envisaged by this disclosure, including the following non-limiting, non-exhaustive example features and arrangements, and combinations of features.

Some example roller bearing units, and/or races, may comprise or consist essentially of polycrystalline super-hard material, such as polycrystalline diamond (PCD), polycrystalline cubic boron nitride (PCBN) and silicon carbide-bonded diamond (SCD) material. The polycrystalline super-hard material may comprise or consist essentially of a plurality of super-hard grains and interstitial volumes between the super-hard grains. In other words, example roller bearing units, and/or races, may comprise or consist essentially of a plurality of super-hard grains interspersed with non-super-hard phase material. At least some, or most, or substantially all the super-hard grains may be directly inter-grown, or bonded to other super-hard grains; or most, or substantially all of the super-hard grains may be spaced apart from other super-hard grains by interstitial volumes. In some examples, the interstitial volumes may form a continuous web, or matrix, extending between a plurality of super-hard grains, or substantially all of the super-hard grains. The interstitial volumes may be at least partly, or substantially entirely filled with a solid, non-super-hard material phase; for example, the interstitial volumes may contain ceramic material, or solvent/catalyst material for diamond or cBN, such as cobalt, and/or iron, and/or nickel, and/or manganese, and/or lithium.

Some example roller bearing units may comprise or consist essentially of PCD material including voids between inter-bonded diamond grains, which may be formed by removing solvent/catalyst material from the PCD material. For example, metallic material including cobalt may be leached from at least a surface region of PCD material. In some example roller bearing units, voids formed by removing solvent/catalyst material may be at least partly filled by a material having a density of substantially less than that of cobalt.

In some examples, a roller bearing may comprise PCD material comprising diamond grains having a mean size (in terms of equivalent sphere diameter) of at most about 15 microns, or at most about 10 microns, and/or at least about 0.5 microns, or at least about 1 micron, or at least about 5 microns, or at least about 10 microns.

PCD material formed of substantially inter-grown relatively small diamond grains may be capable of being polished to have relatively smooth surfaces; and/or may have a combination of relatively high strength and high fracture toughness. While wishing not to be bound by a particular theory, PCD material formed of relatively smaller diamond grains may have a relatively low thermal conductivity, and in some example applications, there may be trade-off between thermal conductivity on the one hand, and strength, toughness, and/or surface smoothness on the other. Certain PCD material comprising relatively larger diamond grains, for example diamond grains having a mean size of at least about 10 microns or at least about 20 microns, may exhibit a higher thermal conductivity, but reduced strength, and may be relatively more difficult (time-consuming or complex) to machine. For example, PCD material formed of relatively coarse grains may require machining by means of a laser beam, or polishing by means of chemical mechanical polishing (CMP).

Some example roller bearing units may comprise polycrystalline super hard material having a mass density (that is, an overall density of the bearing unit) of at most about 4.5 g/cm³; and or at least about 2 g/cm³, or at least about 3 g/cm³. The density of some roller bearing units may be substantially uniform throughout the volume of the bearing unit.

Some example roller-bearings may have thermal conductivity (at 20-25°) of at least about 100 W/m·K, or at least about 300 W/m·K, or at least about 400 W/m·K; and/or at most about 1,000 W/m·K, or at most about 600 W/m·K, or at most about 200 W/m·K. In some example roller bearing units, the thermal conductivity may be substantially isotropic throughout the volume of the bearing unit. In some example roller bearing units, the arithmetic mean thermal conductivity of any volume of at least 1 mm³ within the roller bearing unit may be at least 100 W/m·K.

Some example roller-bearings may have a volume-weighted arithmetic mean coefficient of thermal expansion (at 20-25°) of at most about 5 ppm/K, or at most about 3 ppm/K; and or at least about 1 ppm/K, or at least about 3 ppm/K.

Some example roller-bearings may have a volume-weighted arithmetic mean coefficient of electrical resistivity (at 20-25°) of at least 10⁻² Ω·cm, or at least 1.5×10⁻² Ω·cm, throughout the volume of the roller bearing unit.

Some example roller-bearings may have a volume-weighted arithmetic mean Young's modulus (at 20-25°) of at least about 450 GPa, or at least about 600 GPa, or at least about 750 GPa.

Some example roller bearing units may have a mean tensile strength of at least 1,000 MPa.

Some example roller bearing units may have a self-mated coefficient of friction of at most about 0.5, or at most about 0.3 in dry air; and/or at least about 0.02 with saline solution.

In some examples, the Knoop hardness measured anywhere on the bearing surface of the roller bearing unit, or on any section surface through the roller bearing unit, may be at least about 25 GPa, or at least about 50 GPa. In some example roller bearing units, the hardness may be substantially the same over the entire surface area.

In some examples, a roller bearing unit may be substantially free of a cemented carbide substrate.

Some example roller bearing units may comprise a plurality of different super-hard materials, or different grades of the same kind or super-hard material; an example roller bearing unit may comprise a functionally graded region, which may be coterminous with a bearing surface. In some examples, a microstructural characteristic of the polycrystalline super-hard material comprised in the roller bearing unit may vary with distance from a bearing surface.

In some example arrangements, the roller bearing unit may comprise or consist essentially of a plurality of contiguous super-hard regions, each consisting essentially of a different type, or grade, of super-hard material. For example, one or more of the super-hard regions may be in the form of a layer on another super-hard region; in various examples, the roller bearing unit may comprise a plurality of layers of super-hard material, arranged in contact with each other; and/or the roller bearing unit may comprise a layer of super-hard material, such as a layer of chemical vapour-deposited (CVD) diamond, bonded to a substrate layer of super-hard material, for example silicon carbide-bonded diamond (SCD) material; and/or the roller bearing unit may comprise a plurality of layers of different respective grades of PCD material bonded to each other. An example layer of CVD diamond may have a thickness of at least about 5 microns, and/or at most about 50 microns; or an example layer of SCD may have a thickness of at least about 2 mm, and/or at most about 50 mm.

Some example roller bearing units may comprise graded super-hard material microstructure, in which the microstructure of the super-hard material varies stepwise, or substantially continuously with depth from a surface. For example, a roller bearing unit may comprise polycrystalline super-hard material, in which the mean size, shape or content of super-hard grains, or the content a filler or binder material varies with depth. As an example, a roller bearing unit may comprise a surface region comprising or consisting of a first super-hard material (or grade of a super-hard material), and an inner region relatively remote from the surface comprising or consisting of a second super-hard material (or grade of super-grade material), such that the inner and outer regions have substantially different mechanical, chemical or other properties; for example, the outer region may have a relatively higher hardness than the inner region, and the inner region may be relatively stronger or tougher than the outer region. In other words, some example roller bearing units may comprise functionally graded material composition, or a functionally graded arrangement or materials.

In examples where a bearing surface of a roller bearing unit is defined by PCD material, at least a surface region of the PCD material coterminous with the bearing surface may comprise a relatively small amount of solvent/catalyst material for diamond, or may be substantially devoid of solvent/catalyst material for diamond; for example, the surface region of the PCD material may comprise at most about 2 weight % of solvent/catalyst material for diamond; and/or the surface region of the PCD may contain a plurality of voids. Example solvent/catalyst material for diamond may include iron, nickel, cobalt and manganese, and alloys or mixtures comprising one or more of these.

In some example arrangements, the Young's modulus, and/or the tensile strength, and/or the electrical resistivity, and/or the thermal conductivity, and/or the coefficient of thermal expansion of the roller bearing unit may be isotropic, and/or uniform in magnitude throughout the volume of the roller bearing unit.

Various example bearing assemblies may comprise a plurality of ball bearings, right cylindrical element bearings, tapered element bearings, or needle bearings.

In some example arrangements, a roller bearing unit may be configured for being in linear contact with a race. The roller bearing unit may be formed of a rolling element or a roller element, and be of any shape which has at least one axis that has radial symmetry for example tapered, spherical, oval, and may be for example one or more rolling rods, or a barrel shaped element, and may be configured for being in (notionally) point contact or circular contact with the race. For example, a roller bearing may have a cylindrical or conical bearing surface area, or a roller bearing may be a substantially spherical ball bearing. Some example cylindrical roller bearing units may be barrelled, in which the diameter at an axial midplane may be greater than the diameters at each of the opposite ends of the bearing unit.

Transverse plane cross-sections through example roller bearing units may be substantially circular (transverse planes being perpendicular to the longitudinal rolling axis), the diameter of the section varying by at most about 3 microns, or at most about 2 microns, or at most about 1 micron; and/or the diameter being at least about 1 mm, or at least about 3 mm; and/or at most about 70 mm. Relatively small roller bearing units may be used in dental drill apparatus, for example, and may have a diameter of up to about 3 mm. Some example roller bearing units may have a surface roughness of at most about 3 microns, or at most about 2 microns, or at most about 1 micron, or at most about 0.1 microns. Some example right- or tapered-cylindrical roller bearing units may have a length of at least about 4 mm and/or at most about 70 mm, along the longitudinal axis of rolling rotation.

In some example bearing assemblies, the race may comprise super-hard material, for example PCD, and/or PCBN and/or SCD, one or more characteristics or properties of which may be substantially the same as that of the super-hard material comprised in the roller bearing unit. For example, a race may comprise polycrystalline super-hard material, and have a mean mass density of at most 4.5 g/cm³, and a volume-weighted arithmetic mean thermal conductivity of at least 100 W/m·K. Some example races may comprise polycrystalline super-hard material including interstitial volumes between super-hard grains, the interstitial volumes including non-super-hard material or voids.

In some example arrangements, the roller bearing unit and the race may comprise different super-hard materials, or different grades of the same type of super-hard material; or substantially the same type of super-hard material. In some example arrangements, a race may comprise ceramic material, for example silicon carbide (SiC), or silicon nitride (Si₃N₄); and/or the race may comprise a diamond film, or a diamond-like carbon (DLC) film, joined to SCD material, arranged such that the bearing surface is defined by the diamond film.

In some example arrangements, the bearing assembly may comprise a plurality of race elements, cooperatively configured such that they can be assembled to provide the race. In some examples, the race elements may be joined to a support body by mechanical or adhesive means.

In some example arrangements, the polycrystalline super-hard material comprised in the roller bearing unit, and/or in the race, may be attached to a support body by means of braze material, epoxy adhesive material, mechanical interlock means or interference fit, such as may be achievable by means of press fitting of shrink fitting.

Some example bearing assemblies may comprise an inner race and an outer race, and a plurality of roller bearing units; configured such that the roller bearing units are constrained to roll between the inner and outer races in use, when the inner and outer races rotate relative to each other (the outer race having a greater diameter than the inner race). The inner and outer races including respective grooves, or recesses, configured such that a plurality of roller bearing units can be accommodated in the grooves, and located between the inner and outer races, and roll within the grooves as the inner and outer races rotate coaxially relative to each other. The bearing assembly may comprise a cage configured for holding the roller bearing units in place, and stabilising their position in use. The races may comprise or consist essentially of metal or metal alloy material, for example steel, or technical ceramic material, for example silicon nitride, silicon carbide, or alumina.

In some example arrangements, the roller bearing unit and the race may be cooperatively configured for geared inter-engagement. For example, the roller bearing unit and the race may comprise grooves, or recesses, formed into the respective bearing surfaces, configured operable to inter-engage in use. The roller bearing unit and the race may each comprise elongate gear teeth configured operable to inter-engage in use. In some examples, the grooves or teeth may be helical.

In some examples, the roller bearing unit may include a through-hole, or one or more recesses. While wishing not to be bound by a particular theory, a through-hole or recess may result in a higher rate of heat transport away from the roller bearing unit in use, thus potentially reducing the temperature of the unit under a given set of operating conditions. For example, a roller bearing unit may include a helical, longitudinal or circumferential groove formed into it.

In some examples, the bearing assembly may be for a gas turbine apparatus; in other words, a gas turbine can be provided that comprises an example bearing assembly.

In some examples, an apparatus may comprise gear elements in which gear elements comprise super-hard bearings. Some example turbines may comprise a gear mechanism, in which a gear element comprises a super-hard bearing. For example, a planetary gear mechanism may comprise one or more roller bearing.

Example aircraft propulsion systems can be provided, comprising an example bearing assembly. An example aircraft propulsion system may comprise a rotor mechanism in which power is transmitted to a rotor by a drive mechanism comprising an example bearing assembly. In various examples, an aircraft such as a helicopter may comprise a rotor lift mechanism, in which the rotor mechanism is driven by a rotary drive mechanism comprising an example roller bearing. In some examples, an aircraft or a marine craft may comprise an example rotary propulsion mechanism.

In some example methods of fabricating a roller bearing unit may include fabricating a green body (in other words, an non-sintered body that can be subjected to HPHT sintering to provide a precursor body, which can be processed to provide an example roller bearing unit, or a race element); which may include providing paste comprising super-hard grains and binder material; and injection and/or compression moulding the paste; wet and/or dry bag cold isostatic pressing CIP the paste; and/or subjecting the paste to extrusion, uni-axial pressing, tape casting, slip casting, centrifugal casting, vacuum casting, for example.

In some example methods of fabricating a roller bearing unit, processing the precursor body may be carried out by means of electro-discharge machining (EDM), for example wire EDM (WEDM), and/or by means of laser cutting or machining.

In some example methods, the precursor body may be cylindrical in shape.

Some example methods may include processing the precursor body such that the precursor volume is connected to a residual volume of the precursor body; processing a surface of the precursor volume such that the surface defines dimensions of the roller bearing unit; and processing the precursor body to remove the residual volume.

In some examples, the surface of a roller bearing unit, or a race, may be finished by means of lapping and polishing processes. In some examples, chemical mechanical polishing may be used, and/or a burnishing process may be used.

Non-limiting example arrangements of roller bearing units, bearings assemblies and apparatus comprising same will be described with reference to the accompanying drawings, of which

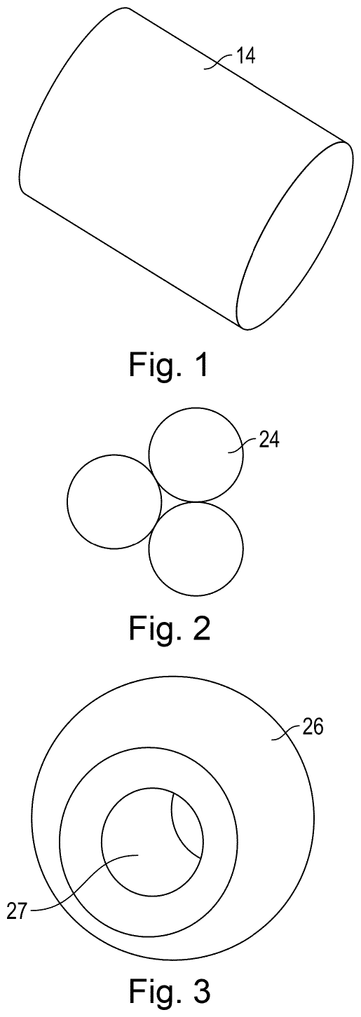

FIG. 1 shows a schematic perspective view of an example right cylindrical roller bearing unit;

FIG. 2 shows a schematic top view of three example spherical roller bearing units (ball bearings);

FIG. 3 shows a schematic perspective view of an example roller bearing including a through-hole for cooling;

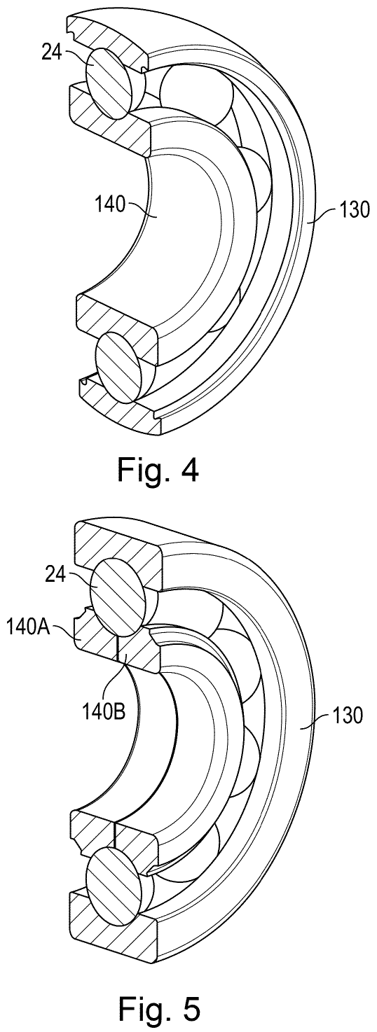

FIG. 4 shows a schematic perspective transverse cross-section view of an example Y ball bearing assembly;

FIG. 5 shows a schematic perspective transverse cross-section view of an example point angular contact roller bearing assembly;

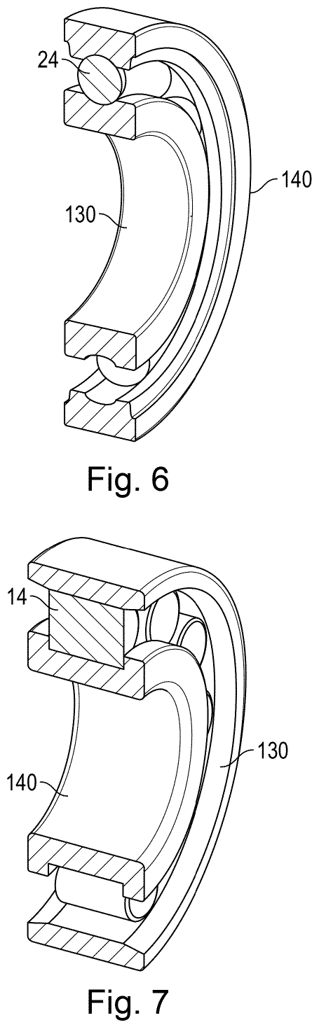

FIG. 6 shows a schematic perspective transverse cross-section view of an example single row deep groove roller bearing assembly;

FIG. 7 shows a schematic perspective transverse cross-section view of an example single row roller bearing assembly;

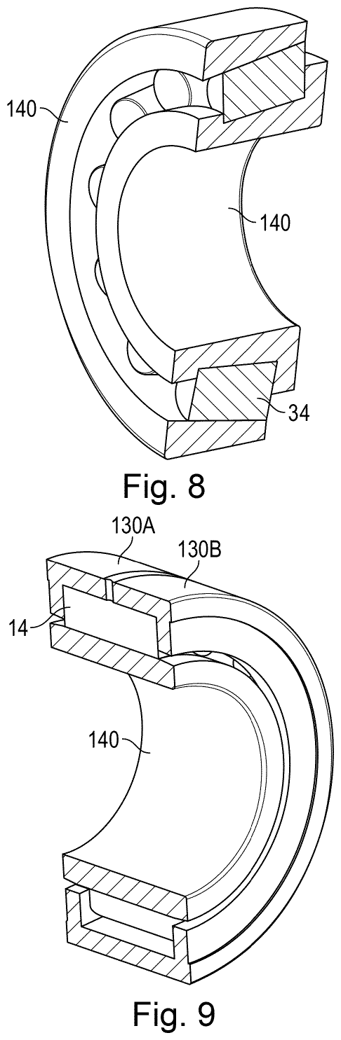

FIG. 8 shows a schematic perspective transverse cross-section view of an example single row taper roller bearing assembly;

FIG. 9 shows a schematic perspective transverse cross-section view of an example needle roller machined race bearing assembly;

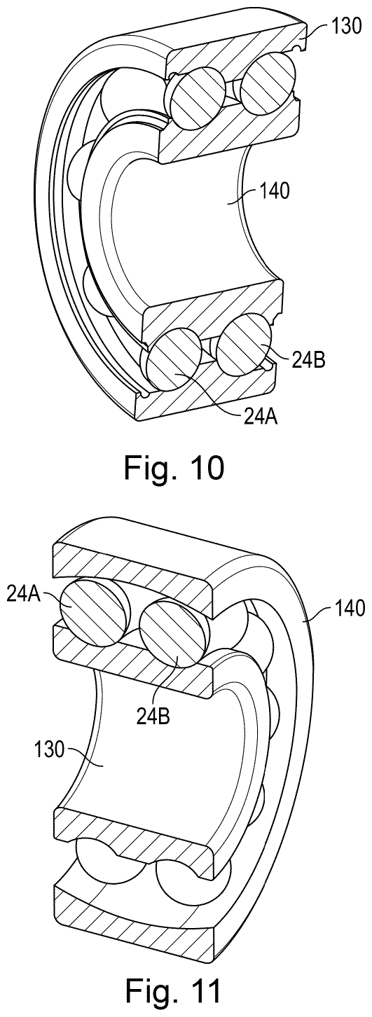

FIG. 10 shows a schematic perspective transverse cross-section view of an example double row angular contact roller bearing assembly;

FIG. 11 shows a schematic perspective transverse cross-section view of an example self-aligning roller bearing assembly;

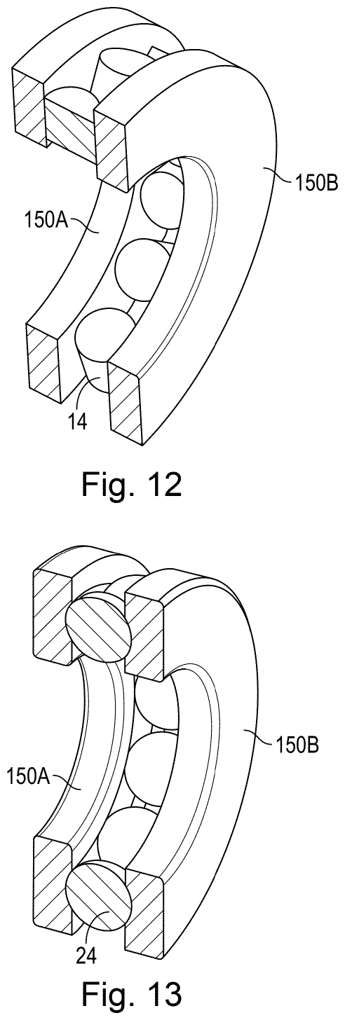

FIG. 12 shows a schematic perspective transverse cross-section view of an example roller thrust bearing assembly;

FIG. 13 shows a schematic perspective transverse cross-section view of an example ball thrust bearing assembly;

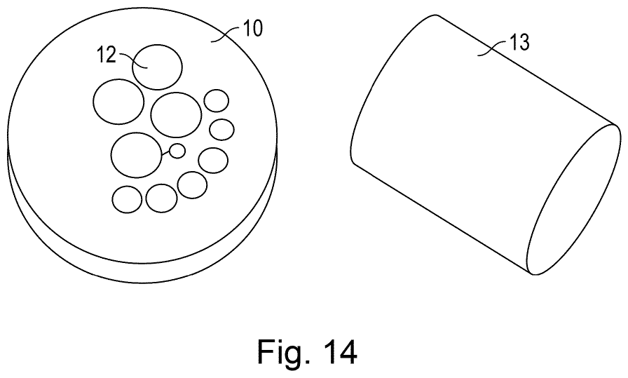

FIG. 14 shows schematic perspective views of a super-hard disc (left) from which cylindrical precursor bodies have been cut, and an example precursor body (right); and

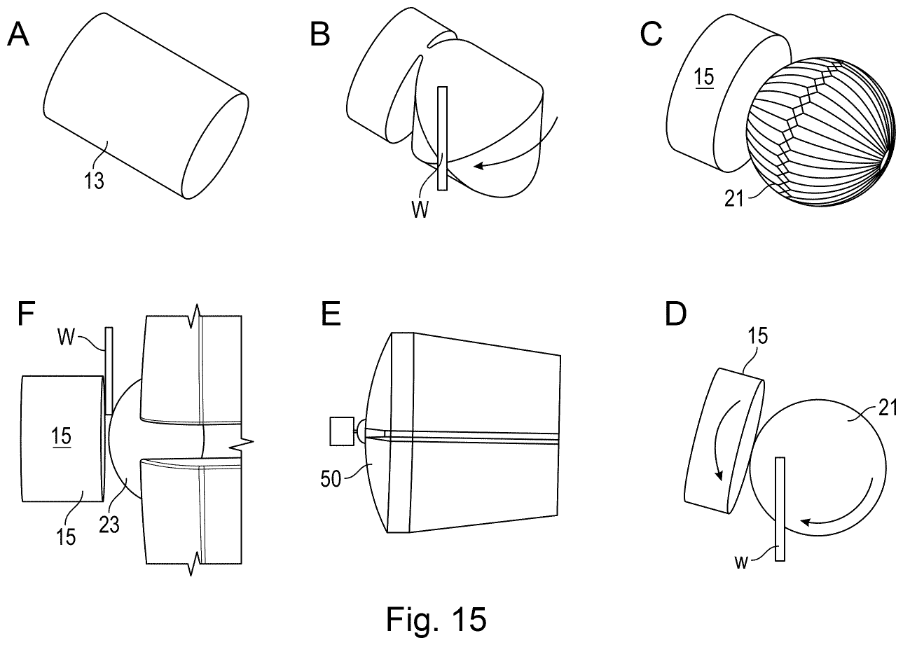

FIG. 15 shows a schematic illustration of a super-hard ball being shaped.

FIG. 1 illustrates an example right cylindrical roller bearing unit 14, FIG. 2 illustrates three example ball bearing units 24 (spherical roller bearings), and FIG. 3 illustrates an example roller bearing unit 26 provided with a diametric through-hole 27. The through-hole 27 may promote cooling of the roller bearing unit when in use, in which through-hole will be coaxial with the rolling axis. These example roller bearings 14, 24, 26 may consist essentially of PCD, or PCBN, or synthetic diamond material fabricated by means of a chemical vapour deposition process, for example.

FIG. 4 to FIG. 13 illustrate various example roller bearing assemblies, showing schematic perspective transverse cross-section views (in other words, the cross-section planes include the respective rotational axes of the roller bearing assemblies; put differently, the rotational axes lie on the respective cross-section planes). Each of the example roller bearing assemblies shown in FIG. 4 to FIG. 11 comprises at least one inner race 140, 140A, 140B and at least one outer race 130, 130A, 130B, and a plurality of roller bearing units 14, 24, 34 arranged between the inner and outer races. The example roller bearing assemblies are configured such that the inner races 140, 140A, 140B and the outer races 130, 130A, 130B are arranged coaxially, and can rotate relative to each other, the roller bearing units 14, 24, 34 rolling against the opposing race surfaces when in use.

FIG. 4 shows an example Y ball bearing assembly comprising an inner race 140, an outer race 130 and a plurality of super-hard ball bearings 24. FIG. 5 shows an example point angular contact roller bearing assembly, comprising two inner races 140A, 140B, an outer race 130 and a plurality of super-hard ball bearings 24. FIG. 6 shows an example single row deep groove roller bearing assembly, comprising a plurality of super-hard ball bearings 24. FIG. 7 shows an example single row roller bearing assembly, comprising a plurality of right cylindrical roller bearings 14. FIG. 8 shows an example single row taper roller bearing assembly, comprising a plurality of taper-cylindrical roller bearing units 34, each having a conical bearing surface. FIG. 9 shows an example needle roller machined race bearing assembly, comprising two outer races 130A, 130B. FIG. 10 and FIG. 11 show example roller bearing assemblies comprising two sets of ball bearings 24A, 24B, the sets arranged parallel and coaxially to each other; FIG. 10 shows an example double row angular contact roller bearing assembly, and FIG. 11 shows an example self-aligning roller bearing assembly.

FIG. 12 and FIG. 13 show example roller thrust bearing assemblies, in which the roller bearings 14 shown in FIG. 12 are right-cylindrical in shape, and those shown in FIG. 13 are ball bearings 24 (as used herein, ball bearings are considered to be examples of roller bearing units).

As used herein, the thermal properties of a material are measured using the laser flash analysis (LFA) method according to the ASTM E1461 standard that is suitable for the kind of material. The thermal conductivity of super-hard material is measured indirectly, by deriving the thermal conductivity from the measured thermal diffusivity, and the density and specific heat capacity of the material, via the equation λ(T)=ρ(T)×cₚ(T)×α(T), where T is the temperature, λ(T) is the thermal conductivity, ρ(T) is the material density, cₚ(T) is the specific heat capacity, and α(T) is the thermal diffusivity. As a non-limiting example, the thermal diffusivity and specific heat capacity may be measured by means of the NETSCH™ laser flash apparatus LFA 467 HyperFiash®. This apparatus was used to measure the thermal properties of PCD material from which example roller bearings were fabricated. Samples of the PCD material were prepared to the dimensions of 10 mm×10 mm×thickness of 2.2-2.4 mm.

The temperature at which the thermal properties are measured was 25° C. Each thermal property for each sample was measured five times, and the mean value was obtained. Prior to the measurement, the opposite ends of each sample were coated with graphite to enhance the emission- and absorption properties of the sample. The specific heat capacity was determined according to the standard ASTM-E 1461-2011. The density of each sample was measured at about 20-25° C. using the buoyancy flotation method.

Various example methods of fabricating PCD and PCBN bodies are known; some example methods are disclosed in WO2013092883, WO2013156536 and WO2012033930. In general, example methods of fabricating a polycrystalline super-hard material such as PCD and PCBN may include sintering an aggregation of super-hard grains, such as diamond or cBN crystallites, in the presence of a sinter catalyst material. The sinter catalyst material may promote the direct inter-bonding, or inter-growth, of the super-hard grains, and/or it may bond to the super-hard grains and connect them. For example, cobalt, iron, nickel and certain alloys including one or more of these metal elements can promote the direct inter-growth of diamond crystallites when the pressure is high enough for the diamond to be crystallographically, or thermodynamically stable, and the temperature is high enough for the metal to be molten.

An example method of making a precursor body for a PCD roller bearing unit may include sintering an aggregation of diamond grains together at an ultra-high pressure of at least about 5.5 GPa, and a temperature of at least about 1,200° C., in the presence of a source of cobalt. The aggregation of diamond grains may be provided in the form of a plurality of sheets, or as an injection moulded paste comprising diamond grains. The diamond grains may have a mean size of at least about 0.1 micron, and/or at most about 30 microns, or at most about 10 microns, and be held together by an organic binder. The sheets may be broken into pieces, or granulated, to provide a plurality of diamond-bearing granules, or flakes. Diamond-containing sheets may be made by extrusion or tape casting methods, wherein slurry comprising diamond grains and a binder material is laid onto a surface and allowed to dry. Other methods for making diamond-bearing sheets may also be used, such as described in U.S. Pat. Nos. 5,766,394 and 6,446,740. In some examples, the aggregation may comprise a mixture of diamond grains and catalyst material for diamond such as Co, Ni, Fe, Mn, which may be combined together by means of milling (e.g. ball billing), and cast into sheets using a plasticizer binder material such as PMMA and DBP.

Some example methods of making PCD material may include mixing diamond grains in the form of powder with powder material comprising cobalt, in elemental or compound form. In some examples, the source of sinter catalyst material may be deposited onto the diamond or cBN grains; for example, an oxide compound including cobalt may be deposited onto diamond grains by a chemical process, and the resulting powder including the deposited material may be treated to remove the oxygen. The amount of cobalt, for example, in the resulting combination may be about 10-30 wt. % (for example, about 20 wt. %). In various examples, the diamond or cBN powder may be provided blending a plurality of powders having substantially different grain size distributions, to provide a multi-modal mixture of powders. For example, diamond grains having a mean grain size of about 1-4 microns may be blended with diamond grains having a mean grain size of about 8-12 microns, to form blended powder having a bimodal size distribution. The diamond or cBN powder and a binder material may be compacted, for example by uniaxial or cold isostatic pressing, to form a green body. The green body may be assembled into a capsule and subjected to heat treatment to remove binder material before subjecting the capsule to an ultra-high-pressure treatment.

In some examples, a PCD disc may be cut up by wire EDM means to provide a plurality of PCD rods, which may be further processed to provide a plurality of PCD balls. The method of processing the PCD rods may include wire EDM, and/or laser ablation; and the method may include lapping and polishing the PCD balls (or cylinders) to provide roller bearing units. The lapping may comprise magnetic float lapping. Examples of float lapping processes have been disclosed by Umehara et al. (“A new apparatus for finishing large size/batch silicon nitride (Si₃N₄) balls for hybrid bearing applications by magnetic float polishing (MFP)”, International Journal of Machine Tools and Manufacture, vol. 46, 2006, pages 151-169); Kirtane, T. S. (“Finishing of Silicon Nitride (Si₃N₄) balls for advanced bearing applications by magnetic float polishing (MFP) apparatus”, Submitted to the Faculty of the Graduate College of the Oklahoma State University, December 2004); U.S. Pat. No. 7,252,576; and Jain, V. K. (“Magnetic field assisted abrasive based micro-/nano-finishing”, Journal of Materials Processing Technology, 209, 2009, pages 6022-6038). Some examples of processing example roller bearing units may include magnetic float chemo-polishing.

With reference to FIG. 14, an example method of making a precursor body 13 for a roller bearing unit 24 may include providing a disc 10 comprising PCD or PCBN material, and using a wire EDM device to cut cylindrical precursor bodies 13 out of the disc 10 (the illustration shows holes 12 in the disc 10 formed when the cylindrical precursor bodies 13 are removed).

FIG. 15 illustrates an example process for making a ball bearing unit 24 by carrying out steps A to F. In step A, a cylindrical precursor body 13 can be provided using the process described with reference to FIG. 14, for example; in step B, a wire electro-discharge (WEDM) apparatus can be used to remove material from the cylindrical precursor body 13 according to a computer-based algorithm (the position of the wire of the WEDM apparatus is indicated schematically by the vertical bar W, and the movement of the wire W is indicated by the arrows). In step C, an indexing spindle may be used to form a faceted sphere 21, still attached to a residual volume 15 of the cylindrical precursor body 13. In step D, WEDM is used with a rotating spindle to form a smoother surface on the faceted sphere 21. In step E, the faceted sphere 21 may be mounted onto a magnetic float polishing apparatus 50, co-axially with the residual volume 15 of the cylindrical element, the faceted sphere 21 held within a collet so that that the residual volume 15 can be removed by WEDM. In step F, the residual volume 15 is removed and the surface of the spherical precursor volume 23 is finished to achieve the desired diameter and sphericity to within ±2.5 microns to provide the ball bearing. In some example methods, laser ablation may be used to remove super-hard material from a sintered precursor body to provide a cylindrical or spherical roller bearing member.

In other example methods, a nearly-spherical precursor body consisting essentially of PCD or PCN can be fabricated by means of a high-pressure sintering process, and WEDM may be used to form a finished ball having the desired diameter and sphericity, within desired tolerances. The near-spherical precursor body may have a diameter of about 10-10.5 mm, and the finished ball bearing unit may have a diameter of 9.0 mm±2.5 microns, in some examples.

Some example methods of making a PCD body may include placing the mixed powders onto a substrate comprising, or consisting essentially of, cobalt-cemented tungsten carbide. The source of cobalt (and/or iron, and/or nickel) may therefore include powder mixed with the diamond powder, and/or molten cobalt or other cementing material that has migrated from the substrate and infiltrating among the diamond, or the cBN, grains during the high-pressure, high-temperature (HPHT) sinter process. The HPHT sinter process may include subjecting diamond or cBN powder grains, proximate a source of cobalt or other suitable sinter catalyst material, to a pressure of at least about 6 GPa, such as about 6.8 GPa, or about 7.8 GPa at a temperature high enough for the cobalt to melt in the presence of the diamond powder.

In some examples, diamond or cBN grains combined with a source of cobalt or other sinter catalyst material, as well as organic binder material, may be formed into spheres and sintered to provide respective spheres of PCD material having a diameter of about 4 mm, or about 10 mm, or about 12 mm. The PCD or PCBN balls may be polished to provide ball bearing units, which may be used in a turbine engine.

Some example roller bearing units may have the aspect of combining a relatively low mass density with a relatively high thermal conductivity, and/or relatively high hardness, and/or relatively low coefficient of thermal expansion, and/or relatively high tensile strength. Such roller elements may have the aspect of being particularly suitable for use in relatively high-speed rotary engines capable of operating at speeds of at least about 1,000 revolutions per minute, particularly but not exclusively for aeronautical propulsion engines. Some example roller bearing units may be capable of operating at relatively high loads, and exhibit relatively low friction, and/or relatively high mechanical shock resistance.

The use of example roller bearing assemblies may allow gas turbines to operate at substantially higher rotational speeds; for example, turbine engines such as aircraft engines comprising example super-hard bearings may have the aspect of operating at higher fan speeds, which may enhance the fuel-efficiency. Super-hard material, which may have relatively high tensile strength, may be advantageous for use in gas turbines that operate at higher rotational speeds, which may require the roller bearing units to sustain greater centripetal forces.

The effect of the bearing surfaces of both the race element and the roller elements being defined by super-hard material such as diamond may be synergistic, since the friction and the wear rate will be relatively low, which will likely enhance the operational efficiency and working life of the bearing assembly.

Some example roller bearing units may have the aspect of exhibiting relatively low rolling resistance, and require reduced energy to move in use. This may be due, at least in part, to their relatively high stiffness.

PCD may be particularly suitable for use in bearing systems, particularly but not exclusively in gas turbines, owing to its combination of relatively low density, relatively low coefficient of friction, relatively low coefficient of thermal expansion, relatively high thermal conductivity, relatively high tensile strength, relatively high abrasive wear resistance, and relatively high Young's modulus. PCBN may also have very suitable properties for use in bearings.

Example roller bearing units may exhibit a combination of increased thermal conductivity with a relatively low density (so that the mass of the bearing will be relatively reduced, all else being equal). Example roller bearings may exhibit reduced magnitude and/or frequency of heat spikes, which may be referred to as hot-spots. This may be desirable in applications where the bearing surface moves at high speed in contact with another surface, and a risk of excessive local heating of the bearing surface may arise due to friction. The risk of hot-spots may be relatively high in bearings used in gas turbines.

Some example super-hard bearing assemblies may have the aspect of requiring relatively little lubricant, or substantially no added lubricant, when in operation, even at relatively high rotation speeds, and/or relatively high operating temperature. For example, some super-hard bearings may be capable of operating at temperatures greater than about 150° C., or at least about 200° C., or at least 300° C. without the application of lubrication fluid. This may have the aspect of avoiding or reducing the need for conduits to convey lubrication fluid to the bearings, thus potentially simplifying the design of a gas turbine.

An apparatus comprising example bearing assemblies may have the aspect of requiring substantially less power to operate, all else being equal, which may be due to the relatively low mass of the roller bearing unit or units.

Some example roller bearing units, and/or races, that comprise a plurality of super-hard grains interspersed with non-super-hard material, or voids, may have the aspect of relatively high toughness and strength; this may potentially be at the expense of reduced hardness and/or thermal conductivity. While wishing not to be bound by a particular theory, the presence of interstitial volume between the super-hard grains may arrest or reduce the propagation of cracks through the material. Also, forming the roller bearing unit of a polycrystalline superhard material such as forming the entire unit of, for example PCD nor PcBN, reduces the weight of the bearing unit over conventionally used materials such as steel, which is believed to reduce the centrifugal force on the roller bearing unit in use, and also reduces the rate of frictional heating. Furthermore, as there is no interface between the polycrystalline super hard material and another material in the roller bearing unit itself, adverse effects on performance or working life which would arise in conventional units that merely have a coating of superhard material on the bulk material such as steel, due to a mismatch in thermal properties between for example the bulk of the roller bearing unit and the coating or layer of superhard material.

Certain terms and concepts as used herein are briefly explained below.

As used herein, super-hard material has a Knoop hardness of at least 25 GPa, and may have a single- or polycrystalline microstructure. For example, polycrystalline super-hard material may comprise or consist essentially of a plurality of super-hard grains (in other words, grains of super-hard material) and a plurality of volumes between the super-hard grains). Unless otherwise stated herein, an intrinsic property of polycrystalline super-hard material is measured for a representative sample of the super-hard material having a volume of at least 1 mm³.

As used herein, different types of polycrystalline super-hard materials may comprise grains of different super-hard materials, and/or different interstitial materials. A used herein, different grades of polycrystalline super-hard material of a given type may have one or more different microstructural and/or compositional characteristic. For example, different grades of PCD material may have different contents of diamond grains; and/or the size distributions of the diamond grains may be substantially different.

Polycrystalline diamond (PCD) material is a type of polycrystalline super-hard material that comprises an aggregation of diamond grains, a substantial portion of which are directly inter-bonded with each other, and in which the content of diamond is at least about 60 volume %, or at least about 80 volume % of the PCD material. Interstices between the diamond grains may be at least partly filled with solvent/catalyst material for synthetic diamond, or they may be substantially empty. As used herein, a solvent/catalyst material for synthetic diamond is capable of promoting the growth of synthetic diamond grains and or the direct inter-growth of synthetic or natural diamond grains at a temperature and pressure at which synthetic or natural diamond is crystallographically stable. Examples of solvent/catalyst materials for diamond are Fe, Ni, Co and Mn, and certain alloys including these. Bodies comprising PCD material may comprise at least a region from which catalyst material has been removed from the interstices, leaving interstitial voids between the diamond grains. Different grades of PCD material may comprise different contents of diamond grains, diamond grains having substantially different size distribution, and/or the composition of the metallic cementing, or interstitial material may differ.

Polycrystalline cubic boron nitride (PCBN) material is a type of polycrystalline super-hard material that comprises grains of cubic boron nitride (cBN) dispersed within a matrix comprising metal and/or ceramic material; the cBN grains may be substantially not inter-bonded with each other. Different grades of PCBN material may comprise different contents of cBN grains, and/or cBN grains having substantially different size distributions, and/or the cementing material may differ substantially.

Other types of super-hard materials may include certain composite materials comprising diamond or cBN grains held together by a matrix comprising ceramic material, such as silicon carbide (SiC), or cemented carbide material, such as Co-bonded WC material (for example, as described in U.S. Pat. No. 5,453,105 or 6,919,040). For example, certain SiC-bonded diamond materials may comprise at least about 30 volume % diamond grains dispersed in a SiC matrix (which may contain a minor amount of Si in a form other than SiC).

As used herein unless stated otherwise, physical properties are measured according to the most recent relevant ASTM (American Standard for Testing and Materials) standard, or the most recent and relevant ISO (International Organisation for Standardisation) standard if there is no suitable ASTM standard. Unless otherwise stated, a given property will be measured at a temperature of 20-25° C.

As used herein unless stated otherwise, the thermal conductivity and elastic modulus (for example, the Young's modulus) of a body comprising different materials or grades of material is calculated based on the relative volumes of the materials, as a volume-weighted arithmetic mean of the respective thermal conductivity of each constituent material or grade of materials. Polycrystalline material such as PCD, PCBN or SCD on the scale of at least 1 mm is treated as a single aggregate material having an average thermal conductivity, since the mean size of the super-hard grains and other regions within these polycrystalline materials is less than about 0.1 mm, unless otherwise stated.

As used herein, the hardness of a body refers to the Knoop indentation hardness, measured according to the ASTM E384 standard and expressed in units of pascals.

As used herein, the phrase “consists essentially of” means “consists of, apart from a non-substantial content of practically unavoidable impurities”.

1. A bearing assembly comprising a roller bearing unit, an inner race and an outer race, the roller bearing unit is formed of polycrystalline super-hard material having a mean mass density of at most 4.5 g/cm³ and a volume-weighted arithmetic mean thermal conductivity of at least 100 W/m·K.

2. A bearing assembly as claimed in claim 1, wherein the polycrystalline super-hard material comprises interstitial volumes between super-hard grains, the interstitial volumes including non-super-hard material or voids.

3. A bearing assembly as claimed in claim 1, wherein the super-hard material is polycrystalline diamond (PCD), or polycrystalline cubic boron nitride (PCBN), or silicon carbide-bonded diamond (SCD) material.

4. A bearing assembly as claimed in claim 1, wherein the roller bearing unit is spherical, right cylindrical, or tapered cylindrical; and the diameter of the roller bearing unit as measured on any plane perpendicular to an axis of rotation in use varies by at most 3 microns.

5. A bearing assembly as claimed in claim 1, wherein the roller bearing unit has a volume-weighted arithmetic mean coefficient of thermal expansion of at most 5.0 ppm/K throughout the volume of the roller bearing unit.

6. A bearing assembly as claimed in claim 1, wherein the roller bearing unit has a volume-weighted arithmetic mean electrical resistivity of at least 10⁻² Ω·cm throughout the volume of the roller bearing unit.

7. A bearing assembly as claimed in claim 1, wherein the roller bearing unit has a tensile strength of at least 1,000 MPa.

8. A bearing assembly as claimed in claim 1, wherein the roller bearing unit has a volume-weighted arithmetic mean Young's modulus of at least 450 GPa.

9. A bearing assembly as claimed in claim 1, wherein the Knoop hardness measured anywhere on the bearing surface of the roller bearing unit, or on any section surface through the roller bearing unit, is at least 25 GPa.

10. A bearing assembly as claimed in claim 1, wherein the roller bearing unit is substantially free of a cemented carbide substrate.

11. A bearing assembly as claimed in claim 1, wherein the roller bearing unit consists essentially of a mass of polycrystalline super-hard material.

12. A bearing assembly as claimed in claim 1, wherein the super-hard material comprises a plurality of directly inter-bonded diamond grains having a size distribution characteristic that the mean equivalent circle diameter is at most 10 microns, as viewed on a section through the super-hard material.

13. A bearing assembly as claimed in claim 1, wherein the roller bearing unit comprises a plurality of different super-hard materials, or different grades of the same kind or super-hard material.

14. A bearing assembly as claimed in claim 1, wherein a microstructural characteristic of the polycrystalline super-hard material comprised in the roller bearing unit varies with distance from a bearing surface.

15. A bearing assembly as claimed in claim 1, wherein the Young's modulus, or the tensile strength, or the electrical resistivity, or the thermal conductivity, or the coefficient of thermal expansion is isotropic, or uniform in magnitude throughout the volume of the roller bearing unit.

16. A bearing assembly as claimed in claim 1, wherein one or other or both of the races comprises super-hard material.

17. A bearing assembly as claimed in claim 1, comprising a plurality of roller bearing units configured such that the roller bearing units are constrained to roll between the inner and outer races in use, when the inner and outer races rotate coaxially relative to each other.

18. A bearing assembly as claimed in claim 1, wherein one or other or both of the races comprise polycrystalline super-hard material having a mean mass density of at most 4.5 g/cm³ and a volume-weighted arithmetic mean thermal conductivity of at least 100 W/m·K.

19. A bearing assembly as claimed in claim 1, wherein one or other or both of the races comprises polycrystalline super-hard material including interstitial volumes between super-hard grains, the interstitial volumes including non-super-hard material or voids.

20. A bearing assembly as claimed in claim 1, wherein one or other or both of the races comprises polycrystalline diamond (PCD), or polycrystalline cubic boron nitride (PCBN), or silicon carbide-bonded diamond (SCD) material.

21. A bearing assembly as claimed in claim 1, wherein the roller bearing unit and one or other or both of the races comprise different super-hard materials, or different grades of the same type of super-hard material.

22.-23. (canceled)

24. A bearing assembly as claimed in claim 1, wherein the roller bearing unit and the races are cooperatively configured for geared inter-engagement.

25.-29. (canceled)

30. A method of making a roller bearing unit for a bearing assembly as claimed in claim 1, including:
a. providing a precursor body including a precursor volume of polycrystalline super-hard material having a mean mass density of at most 4.5 g/cm³ and a volume-weighted arithmetic mean thermal conductivity of at least 100 W/m·K;
b. processing the precursor body to remove material such that the precursor volume is bounded by a surface defining dimensions within 10% of the corresponding dimensions of the roller bearing unit; and
c. processing the precursor volume to provide the roller bearing unit.

31. A method as claimed in claim 30, wherein processing the precursor body is carried out by means of electro-discharge machining.

32.-33. (canceled)

34. A method as claimed in claim 30, including
a. processing the precursor body such that the precursor volume is connected to a residual volume of the precursor body;
b. processing a surface of the precursor volume such that the surface defines dimensions of the roller bearing unit; and
c. processing the precursor body to remove the residual volume.

35. (canceled)
